(19) United States
(12) Patent Application Publication
(10) Pub. No.: US 2015/0120728 A1
(43) Pub. Date: Apr. 30, 2015

(54) E-BOOK SERVICE PROVISION SYSTEM, E-BOOK SERVICE PROVISION METHOD, AND RECORDING MEDIUM

(71) Applicant: Orange Digit Korea Inc., Seoul (KR)

(72) Inventor: Louis BYUN, Gwangmyeong-si (KR)

(73) Assignee: ORANGE DIGIT KOREA INC., Seoul (KR)

(21) Appl. No.: 14/143,654

(22) Filed: Dec. 30, 2013

(30) Foreign Application Priority Data
Oct. 31, 2013 (KR) 10-2013-0131069

(51) Int. Cl. G06F 17/30

(52) U.S. Cl. CPC G06F 17/30876
USPC 707/736

(57) ABSTRACT

An e-book service provision system includes an information receiving unit that receives life log from a life log unit or a reader terminal. A personal information management unit stores the received life log in a personal information D/B or loads the life log stored in the personal information D/B. A life log analysis unit analyzes the life log stored in the personal information D/B and extracts pattern information. A book information management unit stores in a book information D/B the multiple pieces of pattern information and book information that is created corresponding to each of the multiple piece of pattern information, with each of the multiple pieces of pattern information and the book information being matched to each other, or loads the book information stored in the book information D/B. An information provision unit transmits to the reader terminal the book information loaded from the book information management unit.

### CROSS-REFERENCE TO RELATED APPLICATION

Pursuant to 35 U.S.C. §119(a), this application claims the benefit of earlier filing date and right of priority to Korean Application No. 10-2013-0131069, filed on Oct. 31, 2013, the contents of which is incorporated by reference herein in its entirety.

### BACKGROUND OF THE DISCLOSURE

1. Field of the Disclosure

The present disclosure relates to an e-book service, and particularly to an e-book service provision system in which output information is changed according to life log in such a manner that the life log collected through various life log collection units and a reader terminal is analyzed to extract a reader pattern and then book information reflecting the pattern of each reader or an additional service suitable for the reader pattern, an e-book service provision method of changing output information according to life log, and a recording medium on which a program for causing a computer to execute the method.

2. Background of the Disclosure

An e-book is a generic term for a digital book that results from digitizing contents that are or can be published as a book. The digitized contents are recorded on a recording medium and thus are readable, viewable, and audible on a computer a mobile terminal over a wired or wireless network.

A device dedicated to the e-book has been developed that enables characters and images to be displayed using electronic ink in such a manner that the e-book can be output. The electronic ink-based device has an advantage of being excellent in electricity efficiency, but can express the characters and the images in color and cannot emit light by itself. Because of this, the electronic ink-based device has a disadvantage of being unusable in a dark place.

In the recent years, lightweight smart phones and tablet PCs have rapidly come into wide use, which are convenient to use and have functionalities similar to those of a desktop PC. The smart phones and tablet PCs gain more popularity than the desktop PCs in a market of the device that drives the e-book.

However, although the fact that a reader terminal, capable of outputting the e-book, such as a smart phone, or a tablet PC, has a high-level specification, the contents only in the initially-created fixed format that are output from the existing e-book. That is, the contents of a paper book are only converted into a digital format and displayed. The e-book supports only its primary concept of being conveniently portable.

Of course, attempts have been made to depart from such a concept. That is, in Korean Unexamined Patent Application No. 10-2012-0054921 (a device for and a method of providing an e-book service, hereinafter referred to as “related art”) is disclosed a technology of changing initially-provided contents of the book, in which a mark is made at a portion selected by a user or a change is made to the portion selected.

However, the related art does not greatly differ from a function of editing a general document in that the change can be made only to the contents selected by the user.

That is, if output information is unexpectedly provided while the reader reads the e-book, this will prevent the reader from being bored with reading, arousing considerable interest. However, in the related art, the function of simply changing the portion selected by the user does not produce an unexpected effect of arousing interest in reading because the changing of the selected portion reflects the reader's intention.

Moreover, the existing reader terminal does not fully use functions of the device that has a high-level specification and provides only the contents of the book.

### SUMMARY OF THE DISCLOSURE

Therefore, an aspect of the detailed description is to provide a e-book service provision system in which output information is changed according to life log in such a manner that various types of the life log are collected through a reader terminal and various life log collection units for extraction of a reader pattern and then unique book information reflecting the pattern of each reader or an additional service reflecting a personal preference is provided, thereby causing absorption in reading, arousing interest in reading and completing reading, an e-book service provision method of changing output information according to life log, and a recording medium on which a program for causing a computer to execute the method.

To achieve these and other advantages and in accordance with the purpose of this specification, as embodied and broadly described herein, there is provided an e-book service provision system including, an information receiving unit that receives life log from a life log unit or a reader terminal or receives a command to run an e-book from the reader terminal, a personal information management unit that stores the received life log in a personal information D/B or loads the life log stored in the personal information D/B, a life log analysis unit that analyzes the life log stored in the personal information D/B and extracts pattern information, a book information management unit that stores in a book information D/B the multiple pieces of pattern information and book information that is created corresponding to each of the multiple piece of pattern information, with each of the multiple pieces of pattern information and the book information being matched to each other, or loads the book information stored in the book information D/B, and an information provision unit that transmits to the reader terminal the book information loaded from the book information management unit, in which the personal information management unit stores the pattern information extracted from the life log analysis unit in the personal information D/B, in which when a command to run the e-book is input in the specific reader terminal and the information receiving unit receives the command to run the e-book, the personal information management unit checks whether the pattern information is for the specific reader terminal, and in which the book information management unit loads the book information that is matched to the pattern information that is checked by the personal information management unit.

To achieve these and other advantages and in accordance with the purpose of this specification, as embodied and broadly described herein, there is provided an e-book service provision method of changing output information according to life log, including enabling an information receiving unit of an e-book service provision system to receive the life log that is collected through a life log collection unit, enabling a life log analysis unit of the e-book service provision system to analyze the life log and extracting pattern information, enabling a personal information management unit of the e-book service provision system to store the extracted pattern information in a personal information D/B, enabling a book information management unit of the e-book service provision system to store in a book information D/B the multiple pieces of pattern information and book information that is created corresponding to each of the multiple piece of pattern information, with each of the multiple pieces of pattern information and the book information being matched to each other, enabling an information receiving unit of the e-book service provision system to receive a command to run an e-book from a specific reader terminal, enabling a personal information management unit of the e-book service provision system to check the pattern information is for the specific reader terminal, enabling a book information management unit of the e-book service provision system to load the book information that is matched to the pattern information for the specific reader terminal; and enabling an information provision unit of the e-book service provision system to provide the loaded book information to the reader terminal.

To achieve these and other advantages and in accordance with the purpose of this specification, as embodied and broadly described herein, there is provided a recording medium on which a program for causing a computer to execute the e-book service provision method of changing output information according to life log.

According to the present invention, various types of the life log are collected through a reader terminal and various life log collection units and are analyzed to determine a specific pattern or a preference of a reader, and then contents of an e-book reflecting the patter of the reader or an additional service that is satisfactory to the reader is provided, thereby arousing interest in reading. That is, the entire context remains unchanged, and detailed expressions are changed to suit the reader preference and are unexpectedly output. Thus, the reader will be curious about how this occurs. The reader will interestedly enjoy reading.

Furthermore, the additional service that is optimized for the user preference, for example, the coupon that can be used in the cafe, is provided or the store the customer goes regularly is notified, in advance, of the customer preference. Thus, the reader can be provided with a benefit of the additional service and the member store can be provided with an opportunity to attract steady customers with good-quality service.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a block diagram for describing an e-book service provision system in which output information is changed according to life log, according to an embodiment of the present invention;

FIG. 2 is a block diagram for describing a configuration of a reader terminal in the e-book service provision system illustrated in FIG. 1;

FIG. 3 is a view for describing an example of a structure of a book information D/B that is connected to the e-book service provision system illustrated in FIG. 1;

FIG. 4 is a view for describing an example of a structure of a personal information D/B that is connected to the e-book service provision system illustrated in FIG. 1;

FIG. 5 is a flowchart for describing a member registration step that belongs to an e-book provision method of changing the output information according to the life log, according to the embodiment of the present invention;

FIG. 6 is a flowchart for describing a step of collecting the life log and analyzing pattern information that belongs to the e-book provision method of changing the output information according to the life log, according to the embodiment of the present invention;

FIG. 7 is a flowchart for describing a step of providing an additional service, which belongs to the e-book provision method of changing the output information according to the life log, according to the embodiment of the present invention;

FIG. 8 is a view for describing an example in which a coupon resulting from the additional service is output through the reader terminal;

FIG. 9 is a flowchart for describing a step of providing an external service when a reader enters a specific location, which belongs to the e-book provision method of changing the output information according to the life log, according to the embodiment of the present invention;

FIG. 10 is a flowchart for describing a step of changing and outputting e-book output information according to current situation information, which belongs to the e-book provision method of changing the output information according to the life log, according to the embodiment of the present invention;

FIG. 11 is a view for describing an example in which the output information is changed and output through the reader terminal; and

FIG. 12 is a flowchart for describing a step of changing the e-book output information according to the pattern information analyzed through the life log and outputting the changed e-book output information, which belongs to which belongs to the e-book provision method of changing the output information according to the life log, according to the embodiment of the present invention.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Desirable embodiments of the present invention are described below referring to the accompanying drawings. However, some configurations that have no direction relation with the gist of the invention are omitted or condensed, but the omitted or condensed configurations are not unnecessary for the present invention and can be used in combination with other configurations by a person of ordinary skill in the art.

In addition, a constituent unit, a server, and a system that are described below are not independent ones that have to be configured to perform their respective functions. One or more programs, one or more server, one or more, and one or more systems can be totally or partly combined or shared for various configurations.

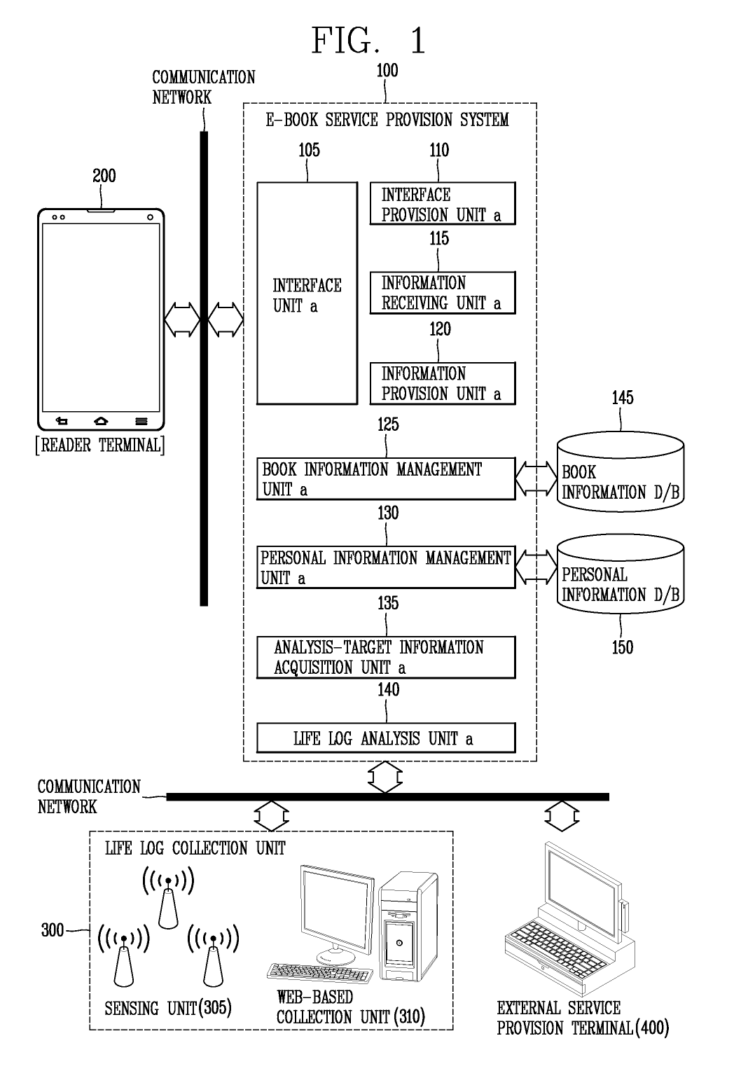

FIG. 1 is a block diagram for describing an e-book service provision system in which output information is changed according to life log according to an embodiment of the present invention (hereinafter referred to as the “e-book service provision system”).

Incidentally, an e-book service provision system 100 illustrated in FIG. 1 is a system 100 that is operated by a publishing company that provides e-book service online or is a system 100 that is operated by a book selling-dedicated website that sells e-books, an open market or an application store.

In addition, the e-book service provision system 100 is connected to a manager terminal (not illustrated) over a network. In the e-book service provision system 100, book information is input and uploaded or the existing book information is amended and updated. The manager terminal is a terminal that is used by the staff at the publishing company, the book selling-dedicated website, the open market, and the application store, who manages the e-books or a terminal that is used by an author of the corresponding e-book.

In addition, a reader terminal 200 is connected to the e-book service provision system 100. Through the reader terminal 200, a payment of a bill for the e-book, that is, the book information, is made and then it is downloaded. Actual output information is output, in the video or audio format, through a display unit or a speaker provided to the reader terminal 200 in order for the reader to access the e-book. The reader terminal 200 includes a notebook computer, a desktop computer, a portable phone, a smart phone, a tablet PC, a smart TV set, and the like. Of course, the reader terminal 200 preferably should be a smart phone or a tablet PC that is capable of collecting or providing location information.

In addition, a life log collection unit 300 collects life log that is basic data for analyzing the reader pattern information. The life log collection unit 300 may be a sensing unit 305 that collects reader-visiting locations. For example, the sensing unit 305 collects visiting locations of the reader terminal 200 using a ubiquitous sensor network (USN). In addition, the life log collection unit 300 may be a web-based collection unit 310 that is connected to a Meteorological Office's server for acquiring weather information, one of pieces of basic data for analyzing pattern information. In addition, the life log collection unit 300 may be a web-based collection unit 310 that is connected to a value-added-network (VAN) company's server for or a credit card company's server for collecting user credit card payment information. In addition, the life log collection unit 300 may be a web-based collection unit 310 that is connected to a portal server for collecting information that results from an Internet search that is made through the reader terminal 200.

An external service provision terminal 400 for providing an additional service to the reader may be a personal computer (PC) or a POS terminal that is installed a company to which the reader makes a visit.

On the other hand, “a” or “b” appended to the name of each constituent unit that is described below is for distinguishing between a constituent unit (to which “a” is assigned) included in the e-book service provision system 100 and a constituent unit (to which “b” is assigned) included in the reader terminal 200. This is for convenience and thus does not attach special meaning to the two constituent units.

As illustrated in FIG. 1, the e-book service provision system 100 includes an interface unit a 105, an interface provision unit a 110, an information receiving unit a 115, an information provision unit a 120, a book information management unit a 125, a personal information management unit a 130, an analysis-target information acquirement unit a 135 and the life log analysis unit a 140.

The interface unit a 105 is provided to establish a communication channel on which information is transmitted and received between the manager terminal, the reader terminal 200, the life log collection unit 300 and the external service provision terminal 400 over a wired or wireless communication network.

The interface provision unit a 110 is provided to provide a user interface for inputting or selecting various pieces of information in the manager terminal or the reader terminal 200, in connection with the interface unit a 105,

For example, the interface provision unit a 110 provides a user interface for uploading new book information to the manager terminal, or provides a user interface for amending the already-uploaded book information in such a manner that the already-uploaded book information is matched to the pattern information or for adding a new item to update the already-uploaded book information.

In addition, the interface provision unit a 110 provides to the reader terminal 200 a user interface for selecting, purchasing, and downloading the e-book, that is, the book information, or to provides an interface for enabling the reader to sign up for a membership.

The information receiving unit a 115 is provided to receive the book information from the manager terminal, to receive the item that is amended or added to update the book information, to receive information for purchasing the book information from the reader terminal 200, receives a command to run the e-book, or to receive a page-turning command, the life log, and current situation information, in connection with the interface unit a 105. In addition, the information receiving unit a 115 is provided to receive the life log or the current situation information received in the life log collection unit 300, in connection with the interface unit a 105.

The information provision unit a 120 is provided to provide the purchase-completed book information to the reader terminal 200, to provide the updated book information, provide the output information or additional information that is changed according to the life log, or to provide the reader pattern information for the additional service to the external service provision terminal 400, in connection with the interface unit a 105.

The book information management unit a 125 is provided to store in a book information D/B 145 the book information that is transmitted from the manager terminal through the information receiving unit a 115 or the amendment information and the additional information for the update, or to load the book information purchased from the reader terminal 200 from the book information D/B 145 and thus provide the loaded book information to the reader terminal 200 in connection with the information provision unit a 120. In addition, the book information management unit a 125 is provided to reflect the current situation information acquired from the life log collection unit 300 or the reader terminal 200 and thus to change the book information. In addition, the book information management unit a 125 is provided to load the book information reflecting the current situation information stored in the book information D/B 145, the book information reflecting the pattern information, or the additional service corresponding to the pattern information.

The personal information management unit a 130 is provided to store in a personal information D/B 150 membership information including personal identification information that is transmitted from the reader terminal 200 through the information receiving unit a 115, to store in the personal information D/B 150 the life log that is collected from the life log collection unit 300 or the reader terminal 200, or to store the pattern information analyzed in the life log analysis unit a 140 in the personal information D/B 150. In addition, the personal information management unit a 130 is provided to check and extract the personal identification information, analysis-target information (the life log) and the pattern information that are stored in the personal information D/B 150.

The analysis-target information acquisition unit a 135 is provided to acquire the analysis-target information for analyzing the pattern information, from the life log collection unit 300 or the reader terminal 200, in connection with the information receiving unit a 115. For example, the analysis-target information acquisition unit a 135 acquires the location information received from the reader terminal 200, the location information received from the sensing unit 305, and the weather information, payment information, and the information resulting from the search that are received from the web-based collection unit 310, as the analysis-target information (the life log) for the analyzing the pattern information. In addition, the analysis-target information acquisition unit a 135 acquires the location information received from the reader terminal 200, the location information received from the sensing unit 305, and the weather information received from the web-based collection unit 310, as the analysis-target information (the current situation information) for providing the service.

The life log analysis unit a 140 receives the reader pattern information, based on the analysis-target information (the life log) that is received in the information provision unit a 120 and that is acquired in the analysis-target information acquisition unit a 135. The pattern information that is analyzed in the life log analysis unit a 140 is stored in the personal information D/B 150 by the personal information management unit a 130.

On the other hand, the book information D/B 145 is a storage medium in which the book information is stored in connection with the book information management unit a 125 of the e-book service provision system 100. The book information that is stored in the book information D/B 145 is such that the current situation information or the pattern information is matched to an insertion position tag indicating an insertion position and the output information that is actually output in the reader terminal 200. The multiple pieces of book information can be stored, in the form of a package. Of course, the output information is collected in real time by the book information management unit a 125.

The personal information D/B 150 is a medium in which personal information is stored in connection with the personal information management unit a 130 of the e-book service provision system 100. The information to be stored in the personal information D/B 150 includes the personal identification information, analysis-target information, and the pattern information.

A function of each of the above-described constituent units of the e-book service provision system 100 is described in detail below.

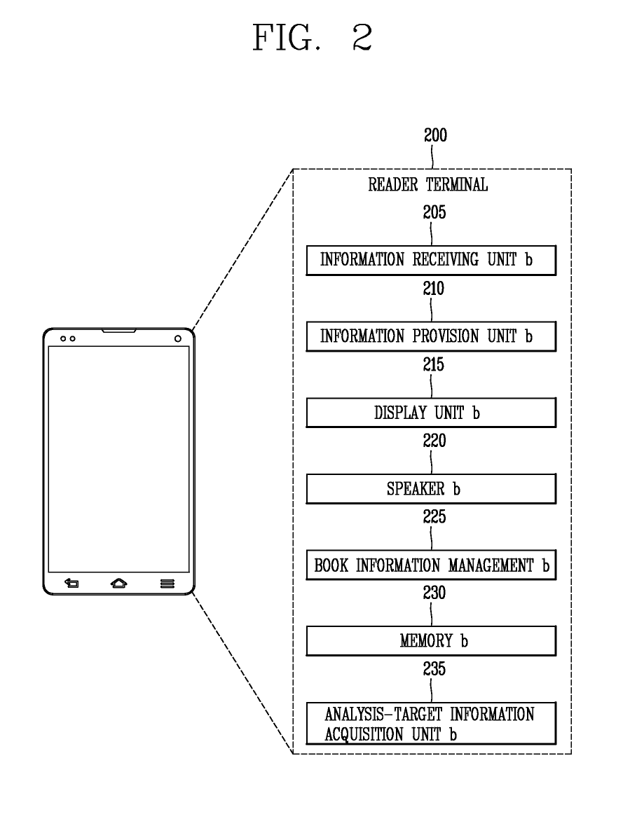

FIG. 2 is a block diagram for describing a configuration of the reader terminal that is connected to the e-book service provision system illustrated in FIG. 1. That is, the reader terminal 200 is a terminal in which the book information is downloaded from the e-book service provision system 100 illustrated in FIG. 1 and is output in the format that the reader can recognize or in which the book information is received in real time from the e-book service provision system 100 and is output.

The reader terminal 200, as illustrated in FIG. 2, includes an information receiving unit b 205, an information provision unit b 210, a display unit b 215, a speaker b 220, a book information management unit b 225, a memory b 230, and the analysis-target information acquisition unit b 235.

The information receiving unit b 205 is provided to receive the user interface from the e-book service provision system 100, to download the book information a purchase of which is requested for, or to receive various pieces of book information that are displayed differently according to the current situation information or the life log, over the communication network.

The information provision unit b 210 is provided to transmit information containing a request for a purchase of the book information to the e-book service provision system 100, to transmit a command to load a specific book, which is input through a key input unit b (not illustrated) to be provided with the book information in real time from the e-book service provision system 100, to transmit to the e-book service provision system 100 the analysis-target information (the life log or the current situation information), such as the location information or selection information that is acquired in the analysis-target information acquisition unit b 235, or transmit to the e-book service provision system 100 page-turning information that is input through the key input unit b.

A display unit b 215 is configured in such a manner that the book information is screen-output in the form of letters or an image on the display unit b 215. The display unit b 215 is configured to serve as a touch screen and thus function as the key input unit b as well.

The speaker b 220 is configured in such a manner that the book information is output in the form of a sound through the speaker b 330.

A book information management unit b 225 is provided to store the book information received through the information receiving unit b 205 in the memory b 230 and to load the book information stored in the memory b 230 according to the current situation information that is acquired in the analysis-target information acquisition unit b 235 according to an input of a command by the reader.

the memory b 230 is a storage medium in which the book information received through the information receiving unit b 205 is stored.

The analysis-target information acquisition unit b 235 is provided to acquire the information for analyzing the life log and the current situation information. For example, the analysis-target information acquisition unit b 235 may be a GPS signal receiving device for acquiring the current location of the reader terminal 200.

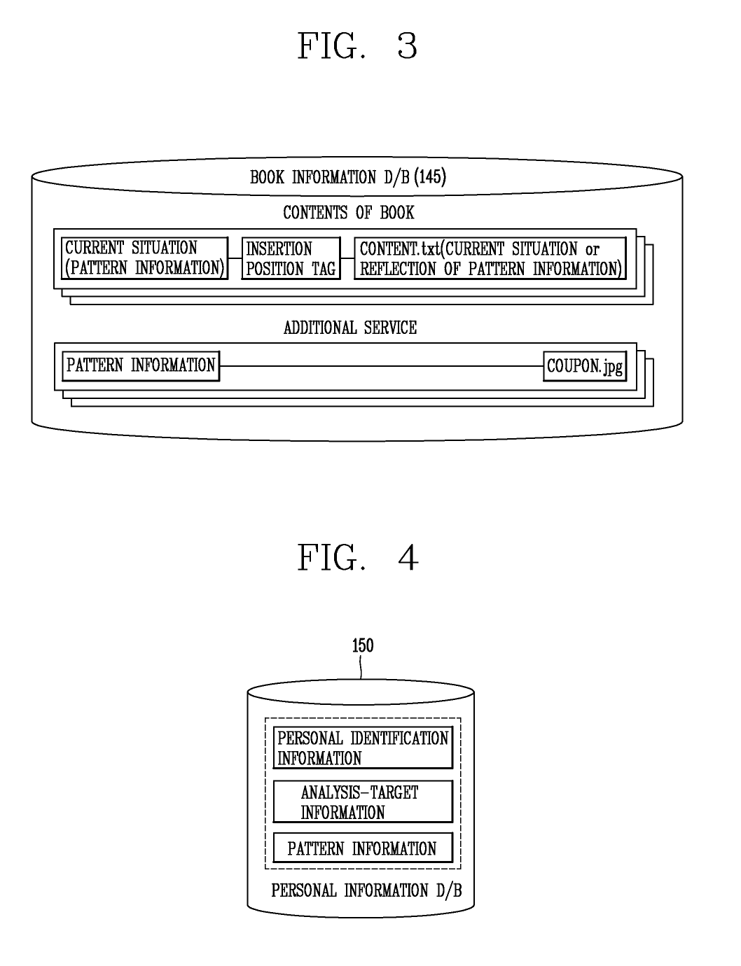

FIG. 3 is a view for describing a structure in which the book information is stored. Here, the pieces of book information may be downloaded in the form of a package and be stored in the memory b 230. The book information may be loaded in real time, in a state of being stored in the book information D/B 145 that is connected to the e-book service provision system 100, then be transmitted to the reader terminal 200, and thus be output. That is, not only a storage structure of the book information D/B 145 that is connected to the e-book service provision system 100 illustrated in FIG. 1, but also the storage structure that is stored in the memory b 230 of the reader terminal 200 illustrated in FIG. 2 is described below referring to FIG. 3. In addition, many of the e-books can be stored in the book information D/B 145 or the memory b 230, but example in which one e-book is stored in the form of one package is described below. In addition, the e-book includes various genres, such as a novel, a fairy tale, a scientific book, and an electronic music book. The form of content provided can be changed according to the genre. As an example of the e-book that has various genres, the novel is described below.

The book information that is output through the display unit b 215 and the speaker b 220 of the reader terminal 200 is configured to come in various forms of content, such as contents of the book, an illustration, background music, an 3D object, a graphic image. In addition, additional-service information, for example, coupon information, that has to be provided to the reader terminal 200 may be additionally included in the book information D/B 145.

Among these, the contents of the book correspond to a plot and are stored in the form of text. Of course, according to the existing conditions, the contents of the book may be stored in the form of an image and may be stored in a specific format (for example, a PDF format) that can be output in a dedicated application. The contents of the book are stored in such a manner that they are matched to the insertion position tag, that is, page information.

In the case of the existing e-book, the book information is stored in such a manner that it is matched only to the insertion position tag (the page information) and the contents of the book and thus only predetermined specific contents of the book can be output to a specific page. However, according to the present embodiment, the book information is stored in such a manner that it is matched to the current situation information or the pattern information, in addition to the contents of the book and the insertion position tag.

According to the present embodiment, although the insertion position (for example, page 4) is the same as the existing position, a specific word or sentence in the contents of the book is stored as reflecting the current situation information or the pattern information acquired from the reader terminal 200 or the life log collection unit 300.

In addition to the contents of the book, the illustration and the background music also can be stored, in an image file or a sound file, in the book information D/B 145, and furthermore, the multiple illustration and the multiple pieces of background music are stored with each illustration and each piece of background music being matched to the insertion position tag and the current situation information (or the pattern information).

The multiple pieces of book information, in each of which the current information or the pattern information is matched to the insertion position tag are combined in sets. The book information in this form of a package is stored as one e-book in the book information D/B 145 and the memory b 230. Of course, the book information, as described above, may further include a different type of content, such as the 3D object and the graphic image.

On the other hand, along with the current situation information (the pattern information) and the insertion position tag, the contents, the image, and the sound are matched to the contents of the book, the illustration, the background music, and the like that make up the book information. Among these, only the contents, the image, the sound are actually output through the reader terminal 200 (the page information may be furthermore output according to the existing conditions). The contents, the image, and the sound information that are actually output through the reader terminal 200 are referred to the output information.

In each content that makes up the book information, each of the general document files, the image file and the sound file are matched to the current situation information (the pattern information) and the insertion position tag. The multiple pieces of the content, each with this configuration, are stored. The e-book that is configured as one set in this manner can be stored in a standard format such as ePub or aze.

FIG. 4 is a view for describing an example of the structure of the personal information D/B 150 in which the personal information is stored in connection with the personal information management unit a of the e-book service provision system. The personal information stored in the personal information D/B 150 includes the personal identification information (ID, a telephone number, a serial number of the terminal, and the like) on each member, the analysis-target information (the life log) acquired in the reader terminal 200 or the life log collection unit 300, and the pattern information analyzed in the life log analysis unit a 140.

The functions of the e-book service provision system 100 and the functions of the reader terminal 200 that are described above are made more apparent by describing below an e-book provision method of changing the output information according to the life log.

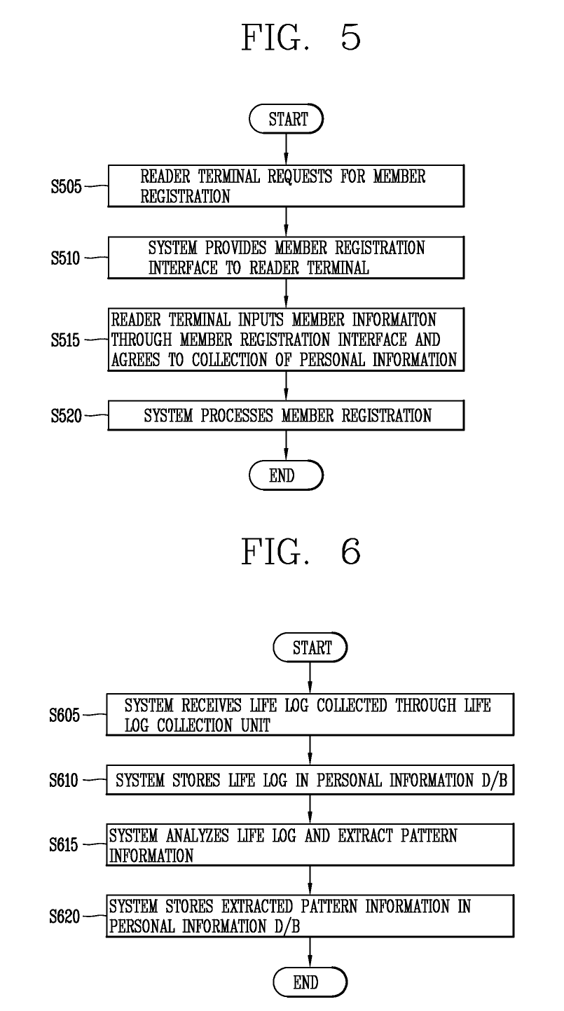

FIG. 5 is a flowchart for describing a member registration step that belongs to the e-book provision method of changing the output information according to the life log, according to the embodiment of the present invention. The e-book service provision system is hereinafter referred to as the “system” for convenience.

First, in order to be provided with the service according to the embodiment of the present invention, the reader have access to a web page through the reader terminal 200 or have access to the system 100 by running a dedicated application and then requests for the member registration (S505). When this is done, the interface provision unit a 110 of the system 100 provides a member registration interface to the reader terminal 200, in connection with the information provision unit a 120 (S510).

Subsequently, when the reader inputs the membership information including the personal identification information through the member registration interface in the reader terminal 200 and agrees to collection of the personal information (S515), the personal information management unit a 130 of the system 100 stores the membership information in the personal information D/B 150 and processes the member registration request (S520).

The personal identification information here includes the member ID, the name, the telephone number (the terminal number), the serial number of the terminal. The personal identification information is input through the reader terminal 200 or is automatically collected in the reader terminal 200.

Because information involving reader privacy, such as reader location information, has to be collected to provide the service according to the present invention, this necessarily requires a member registration procedure and a procedure for agreeing to the collection of the life log, which is a target of analysis, such as the location information or the payment information.

FIG. 6 is a flowchart for describing a step of collecting the life log and analyzing the pattern information that belongs to the e-book provision method of changing the output information according to the life log, according to the embodiment of the present invention.

That is, the life log collection unit 300 collects the life log at all times from the reader terminal 200 that goes through the member registration in the steps in FIG. 5 and transmits the collected life log to the system 100. The analysis-target information acquisition unit a 135 of the system 100 receives the life log in connection with the information receiving unit a 115 (S605). The life log includes the location information on the reader terminal 200, which is received through the reader terminal 200 or the sensing unit 305, the current weather information that is collected through the web-based collection unit 310, or the information on the payment that is made with a credit card by the reader, the information resulting from the search of the portal or the like.

The life log that is received in the system 100 is stored as the analysis-target information on the corresponding member in the personal information D/B 150 by the personal information management unit a 130 (S610).

Subsequently, in connection with the personal information management unit a 130, the life log analysis unit a 140 of the system 100 analyzes the analysis-target information, that is, the life log, stored in the personal information D/B 150 and extracts the reader pattern information.

For example, as a result of analyzing the life log, the life log analysis unit a 140 extracts the pattern information that when it rains (this is determined by acquiring the weather information through the web-based collection unit 310) goes to a specific cafe (this is determined based on the location information collected through the sensing unit 305 installed in the cafe) and places an order for a specific food (this is determined by collecting through the web-based collection unit 310 the information on the payment that is made in the cafe.

The point in time when the pattern information is extracted preferably should be after a given amount of life log or greater is collected.

The pattern information that is extracted in the life log analysis unit a 140 of the system 100 is stored in the personal information D/B 150 by the personal information management unit a 130 (S620).

Here, the step of collecting the life log is performed at all times even after the pattern information is extracted and is stored in the personal information D/B 150. When the given amount of life log is collected, the step of analyzing the life log is additionally performed and thus the pattern information is added or updated.

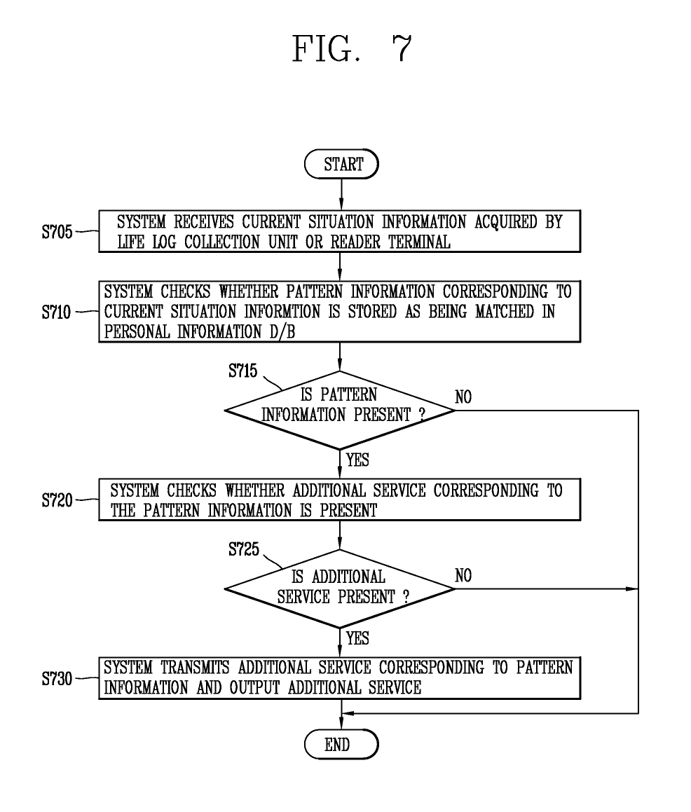

FIG. 7 is a flowchart for describing a step of providing the additional service, which belongs to the e-book provision method of changing the output information according to the life log, according to the embodiment of the present invention. That is, in this step, the additional service is provided to the reader who finishes the member registration step in the step in FIG. 5 and whose pattern information is extracted in the step in FIG. 6.

The life log collection unit 300 and the reader terminal 200 collects the current situation information at all times and transmits the collected current situation information to the system 100. In connection with the information receiving unit, the analysis-target information acquisition unit a 135 of the system 100 acquires the current situation information that is received from the life log collection unit 300 and the reader terminal 200 (S705). For example, the analysis-target information acquisition unit a 135 acquires the weather information that it rains now, through the web-based collection unit 310.

Subsequently, the personal information management unit a 130 of the system 100 checks whether the pattern information corresponding to the current situation information that is acquired through the personal information D/B 150 by the analysis-target information acquisition unit a 135 is stored as being matched to the personal information on a specific reader (S710). If it is ensured that the personal information has the pattern information corresponding to the current situation information (S715), the book information management unit a 125 of the system 100 checks whether the additional service that is stored as being matched to the corresponding to the pattern information is present (S720). For example, it is checked whether the pattern information relating to a rainy day is present.

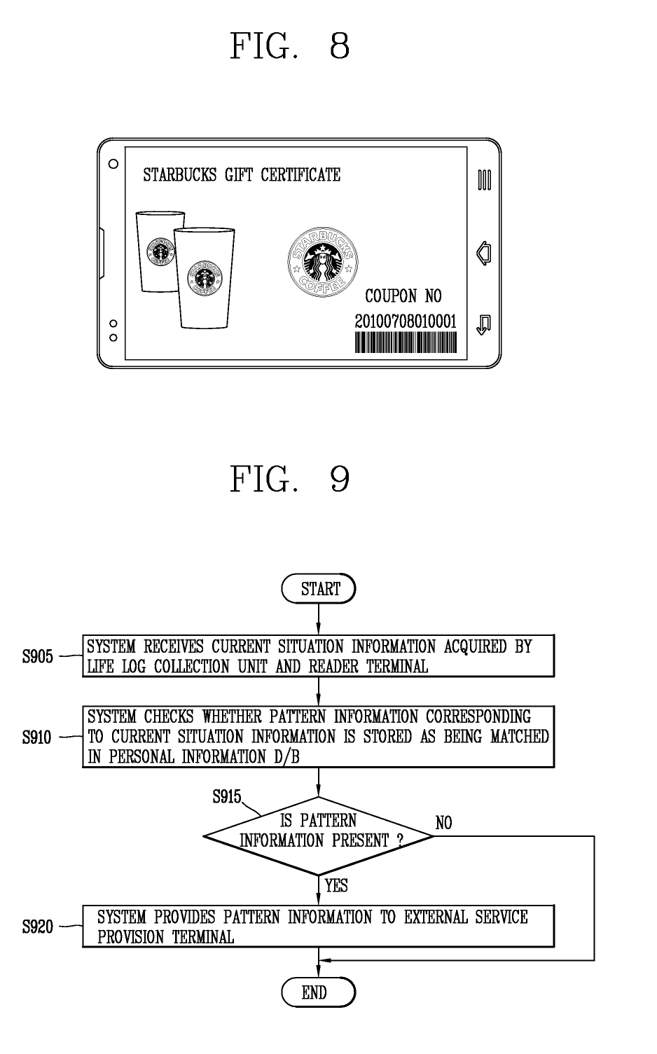

If it is ensured that the personal information has the pattern information corresponding to the current situation information (S725), the system 100 transmits the additional information corresponding to the pattern information to the corresponding reader terminal 200 in order to output the additional information (S730). For example, the additional service may be a coupon with which a corresponding customer can place an order for a specific food or receive a favorable discount in the restaurant where he/she goes. Therefore, as illustrated in FIG. 8, the coupon can be provided that can be used in the restaurant where the reader goes frequently.

If the reader runs the e-book through the reader terminal 200, an additional service (coupon) screen pops up or is displayed on the margin of a specific page. In contrast, if the reader does not run the e-book, the reader can be notified that the additional service (the coupon) is provided, using a push function.

In this manner, when a reader preference, that is, the reader pattern information is checked through the reader life log and then a specific situation arrives, the additional service for which the reader has a preference is provided. Thus, a benefit can be provided that is satisfactory to the reader. Of course, the additional service, such as the coupon, is issued only to a member store that signs up for the present service and the member store can secure as regular customers the customers that are satisfied with the service.

FIG. 9 is a flowchart for describing a step of providing an external service when the reader enters a specific location, which belongs to the e-book provision method of changing the output information according to the life log, according to the embodiment of the present invention. That is, in this step, the external service is provided to the reader who finishes the member registration step in the step in FIG. 5 and whose pattern information is extracted in the step in FIG. 6.

When the life log collection unit 300 or the reader terminal 200 collects the current situation information, the analysis-target information acquisition unit a 135 of the system 100 acquires the current situation information in connection with the information receiving unit a 115 (S905). For example, when the reader carrying the reader terminal 200 goes to the cafe where he/she goes regularly, the sensing unit 305 recognizes the corresponding reader terminal 200 and transmits the information on the reader terminal 200 to the system 100.

Subsequently, the personal information management unit a 130 of the system 100 checks whether the pattern formation corresponding to the current situation information on the corresponding customer, which is acquired through the personal information D/B 150 by the analysis-target information acquisition unit a 135, is stored as being matched (S910).

If it is ensured that the pattern information corresponding to the current situation information on the corresponding customer is stored as being matched (S915), the personal information management unit a 130 of the system 100 extracts the pattern information that is stored as being matched, and provides the extracted pattern information to the external service provision terminal 400 (S920).

For example, if the current situation information is “weather—rain,” the pattern information is “weather—rain, preference menu—vanilla lait,” as soon as the reader enters the cafe, a corresponding customer's preference is displayed on the external service provision terminal 400, such as a PC or a POS terminal in the member store. Thus, the staff at the cafe is aware, in advance, that when it rains, the corresponding customer will place an order for vanilla lait. With this information, the staff can give good service to the corresponding customer.

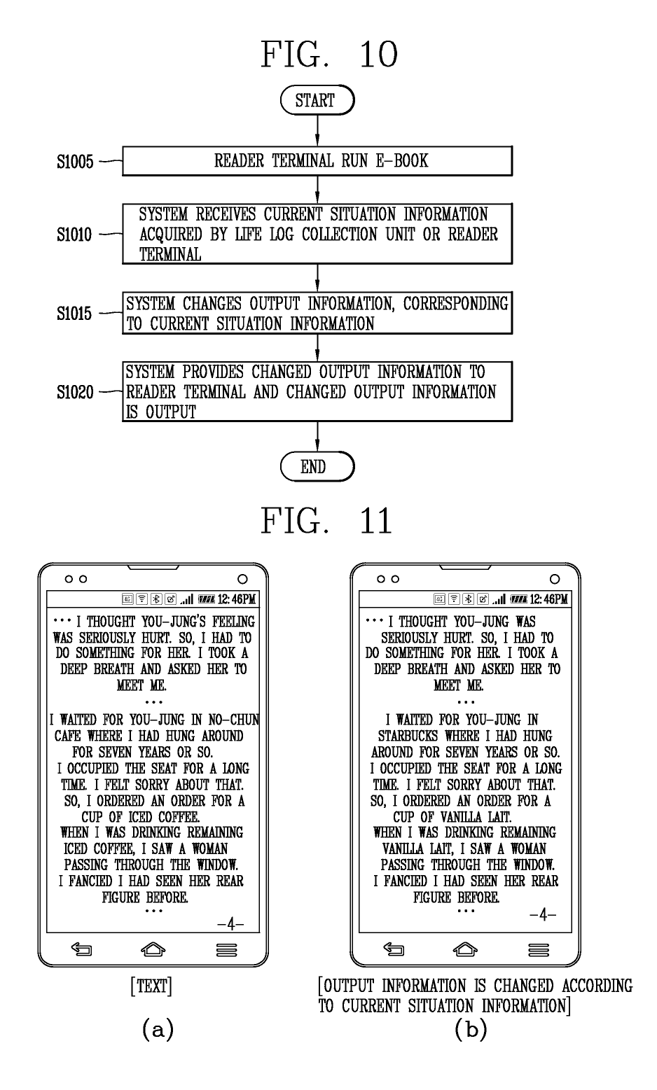

FIG. 10 is a flowchart for describing a step of changing and outputting the e-book output information according to the current situation information, which belongs to the e-book provision method of changing the output information according to the life log, according to the embodiment of the present invention.

If the reader runs the e-book on the reader terminal 200 for reading a book (S1005), the command to run the e-book is transmitted to the system 100, and the analysis-target information acquisition unit a 135 of the system 100 acquires the current situation information from the life log collection unit 300 or the reader terminal 200 (S1010).

Subsequently, the book information management unit a 125 of the system 100 changes the output information on a specific location, which has to be provided to the reader terminal 200, corresponding to the current situation information acquired by the analysis-target information acquisition unit a 135 (S1015). The book information management unit a 125 loads the changed output information and provides the output information to the reader terminal 200, in connection with the information provision unit a 120 (S1020).

For example, if the reader enjoys reading after placing an order for a specific food at the cafe where he/she goes regularly, among the contents of the book, the name of the cafe and the name of the beverage are changed in a manner that suits the reader's preference and are output as changed.

Therefore, the reader unexpectedly reads the story reflecting the current situation which he/she is now in and will be curious about how this occurs. The reader will interestedly enjoy reading.

A method of providing e-book information from the system 100 to the reader terminal 200 in a streaming format is described above, but the e-book information may be already in a state of being downloaded to the reader terminal 200 and of being stored in the memory b 230. In this case, a dedicated application for running the e-book may acquire the current situation information, and then perform the process in such a manner that the already-stored book information is changed and then output.

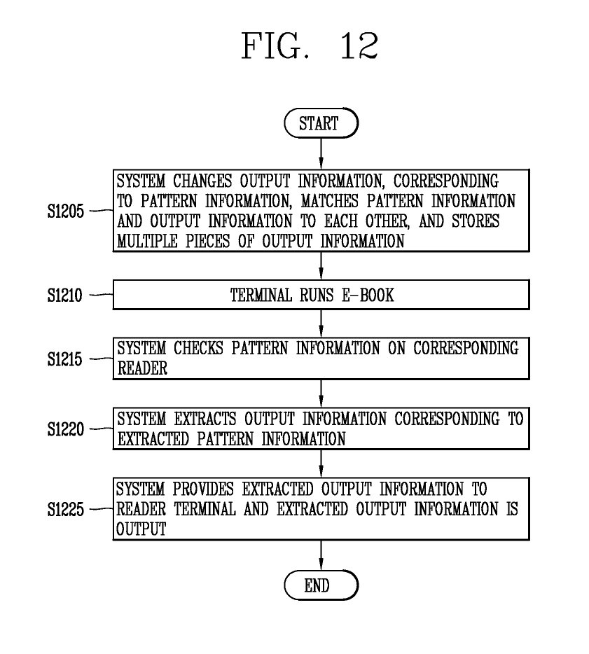

FIG. 12 is a flowchart for describing a step of changing the e-book output information according to the pattern information analyzed through the life log and outputting the changed e-book output information, which belongs to which belongs to the e-book provision method of changing the output information according to the life log, according to the embodiment of the present invention.

That is, when the pattern information extraction and storage is performed on a specific reader in the step in FIG. 6, the book information management unit a 125 of the system 100 changes the output information, corresponding to the pattern information through the book information D/B 145 and then matches the pattern information and the output information (the contents of the book) to each other. The book information management unit a 125 stores the multiple pieces of output information in the form of a package (S1205). Here, the output information, such as the contents of the book, may be changed, as programmed in advance, by the book information management unit a 125 itself, but when various pieces of pattern information occurs by the numerous readers, the change by the book information management unit a 125 itself may be not possible. Therefore, each time the pattern information occurs, the pattern information is output to the manager terminal. Then, the output information, such as the contents of the books, is changed by an operator. Then, the pattern information and the output information may be matched to each other and be stored in the book information D/B 145.

When the reader runs the e-book through the reader terminal 200 in a state where the contents of the book are matched to each of the multiple pieces of pattern information and are combined with each of the multiple pieces of pattern information in the form of a package (S1210), the command to run the e-book is transmitted to the system 100 and the personal information management unit a 130 of the system 100 checks the pattern information on the corresponding reader through the personal information D/B 150 (S1215). Subsequently, through the book information D/B 145, the book information management unit a 125 of the system 100 extracts the output information (that is, the contents of the book) corresponding to the pattern information extracted from the personal information management unit a 130, and the information provision unit a 120 provides the extracted output information to the reader terminal 200 for outputting the extracted output information (S1225).

For example, it is assumed that as a result of analyzing the reader life log, the pattern information occurs that when it's hot, the reader places an order for a chicken and a glass of beer at the pub. If this pattern information is in a state of being stored in the personal information on the corresponding reader, when the reader runs the e-book for reading, a name of the corresponding pub and a menu appears on specific contents of the book. Of course, there is no change in the context of the entire contents of the book, and some words and material are in a state of being changed to reflect the reader pattern. Therefore, the reader will feel that the leading character has the same preference as he/she and will interestedly read the e-book.

Of course, although a specific pattern information occurs by analyzing the life log, the page in which to reflect the reader pattern cannot be present. In this case, because the pattern information and the contents of the book are not stored as being matched to each other, the corresponding page is provided as is without any change to it.

As described above, according to the present invention, the life log is collected by various routes and is analyzed to determine a specific pattern and preference of the reader. Then, the providing of the contents of the book to reflect the reader pattern or the providing of the additional service that is satisfactory to the reader can excite the reader's interest in reading. That is, the entire context remains unchanged, and detailed expressions are changed to suit the reader preference and are unexpectedly output. Thus, the reader will be curious about how this occurs. The reader will interestedly enjoy reading.

Furthermore, the additional service that is optimized for the user preference, for example, the coupon that can be used in the cafe, is provided or the store the customer goes regularly is notified, in advance, of the customer preference. Thus, the reader can be provided with a benefit of the additional service and the member store can be provided with an opportunity to attract steady customers with good-quality service.

On the other hand, when the e-book service provision system 100 in which the output information is changed according to the life log described above is used, the following service can be provided.

First, the e-book service can be used to help a student do studying. For example, if the student takes a lesson using a text in the form of the e-book before the reader terminal 200 at school or at an educational institute, when the student comes home and runs the e-books to do studying, the current situation information (home) is acquired in the sensing unit 305 or the reader terminal 200 and then contents of the study or a homework can be output in accordance with progress in classwork at school or at, the educational institute.

Second, if the user takes a lesson in recognition skill improvement, such as a pictorial puzzle game, through the reader terminal 200, after he/she does learning repeatedly and thus reaches a given level, new learning information can be output. For example, if with the help of his/her parent, a child does learning through an animal-name matching game with reference to a pictorial fairy tale in the form of the e-book that is output on the reader terminal 200, when the child finds answers by a given number of times or more, the contents of the book can be changed in such a manner that a difference animal appears in the game.

In this manner, after the reader pattern or the learning situation is determined with the analysis-target information including the life log and the current situation information, when the service is provided such that the output information, such as the contents of the book or the illustration is changed and is output in accordance with the reader preference and the progress in the learning, a range in which the e-book is used can be broadened.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

1. An e-book service provision system comprising:
an information receiving unit that receives life log from a life log unit or a reader terminal or receives a command to run an e-book from the reader terminal;
a personal information management unit that stores the received life log in a personal information D/B or loads the life log stored in the personal information D/B;
a life log analysis unit that analyzes the life log stored in the personal information D/B and extracts pattern information;
a book information management unit that stores in a book information D/B the multiple pieces of pattern information and book information that is created corresponding to each of the multiple piece of pattern information, with each of the multiple pieces of pattern information and the book information being matched to each other, or loads the book information stored in the book information D/B; and
an information provision unit that transmits to the reader terminal the book information loaded from the book information management unit,
wherein the personal information management unit stores the pattern information extracted from the life log analysis unit in the personal information D/B,
wherein when a command to run the e-book is input into the specific reader terminal and the information receiving unit receives the command to run the e-book, the personal information management unit checks whether the pattern information is for the specific reader terminal, and
wherein the book information management unit loads the book information that is matched to the pattern information that is checked by the personal information management unit.

2. An e-book service provision method of changing output information according to life log, comprising:
enabling an information receiving unit of an e-book service provision system to receive the life log that is collected through a life log collection unit;
enabling a life log analysis unit of the e-book service provision system to analyze the life log and extracting pattern information;
enabling a personal information management unit of the e-book service provision system to store the extracted pattern information in a personal information D/B;
enabling a book information management unit of the e-book service provision system to store in a book information D/B the multiple pieces of pattern information and book information that is created corresponding to each of the multiple piece of pattern information, with each of the multiple pieces of pattern information and the book information being matched to each other;
enabling an information receiving unit of the e-book service provision system to receive a command to run an e-book from a specific reader terminal;
enabling a personal information management unit of the e-book service provision system to check the pattern information is for the specific reader terminal;
enabling a book information management unit of the e-book service provision system to load the book information that is matched to the pattern information for the specific reader terminal; and
enabling an information provision unit of the e-book service provision system to provide the loaded book information to the reader terminal.

3. A recording medium on which a program for causing a computer to execute the method according to claim 2 is stored.
